(19) United States
(12) Patent Application Publication
(10) Pub. No.: US 2026/0270243 A1
(43) Pub. Date: Sep. 10, 2026

(54) Advanced Cryptographic Encoding System for Secure Digital Communication and Data Protection

(71) Applicant: Darren KANE, DUBLIN (IE)

(72) Inventor: Darren KANE, DUBLIN (IE)

(21) Appl. No.: 19/075,640

(22) Filed: Mar. 10, 2025

(51) Int. Cl. H04L 9/40; H04L 9/32

(52) U.S. Cl. CPC H04L 63/0428; H04L 9/321

(57) ABSTRACT

This invention provides an alternative cryptographic encoding system to enhance digital security and data protection. It employs a structured encoding transformation process, ensuring protection against AI, quantum computing, and unauthorized access attempts. The system applies multi-layer security principles and configurable encryption adaptability across multiple industries. The encoding methodology is dynamically adjustable, maintaining security resilience without reliance on static encryption keys.

### CROSS-REFERENCE TO RELATED APPLICATIONS

This application does not claim priority to any prior U.S. or foreign patent applications.

### STATEMENT REGARDING FEDERALLY SPONSORED RESEARCH OR DEVELOPMENT

This invention was not developed under federally sponsored research, nor does it contain any federally funded components.

### FIELD OF THE INVENTION

The present invention relates to next-generation cryptographic security, specifically an alternative cryptographic encoding system designed for secure digital communication, authentication, and data protection. This encoding framework may be applied to structured data across multiple digital security applications.

This invention introduces an advanced encryption methodology, eliminating reliance on traditional computational key-based encryption models and instead applying a structured transformation process to secure digital information against computational and non-computational decryption attempts.

### BACKGROUND OF THE INVENTION

### Limitations of Traditional Encryption

Existing encryption systems, including RSA, AES, ECC, and SHA-256, rely on mathematical computations that are vulnerable to:

Quantum Computing Attacks—Future quantum systems, using Shor's and Grover's algorithms, are expected to compromise conventional cryptography by efficiently factoring large prime numbers and reducing search complexity.

AI-Powered Decryption—Machine learning algorithms can analyze patterns in traditional encryption models, accelerating brute-force attack efficiency.

Static Key Management Vulnerabilities—Standard encryption relies on fixed key structures, increasing risks of exposure, theft, or unauthorized duplication.

### Need for a New Encoding Approach

This invention introduces a novel cryptographic security system that applies a structured encoding transformation process, eliminating reliance on conventional encryption key structures while ensuring enhanced security integrity against computational decryption methods.

Unlike traditional encryption, which depends on numeric key complexity, this system implements an alternative cryptographic encoding framework, ensuring data security through structured transformation principles.

### SUMMARY OF THE INVENTION

This invention provides a next-generation cryptographic encoding system that enhances digital security, authentication, and communication encryption by using a structured transformation-based encoding methodology resistant to traditional decryption methods.

### Core Functional Benefits

Eliminates reliance on computational key-based encryption.

Protects against AI, quantum, and brute-force attacks.

Ensures encryption integrity through structured transformation processes.

Provides adaptable encryption models for multiple communication and storage environments.

Unlike conventional encryption, this system removes direct reliance on computational cryptographic keys, replacing them with a structured encoding system that remains resistant to AI-based pattern detection, quantum computing decryption, and brute-force exploitation.

### Enhancements From Refinements

The encoding process is now explicitly dynamic, allowing for real-time security adaptation.

Multi-layer encoding structures adjust based on evolving security conditions without reliance on static encryption keys.

### BRIEF DESCRIPTION OF THE DRAWINGS

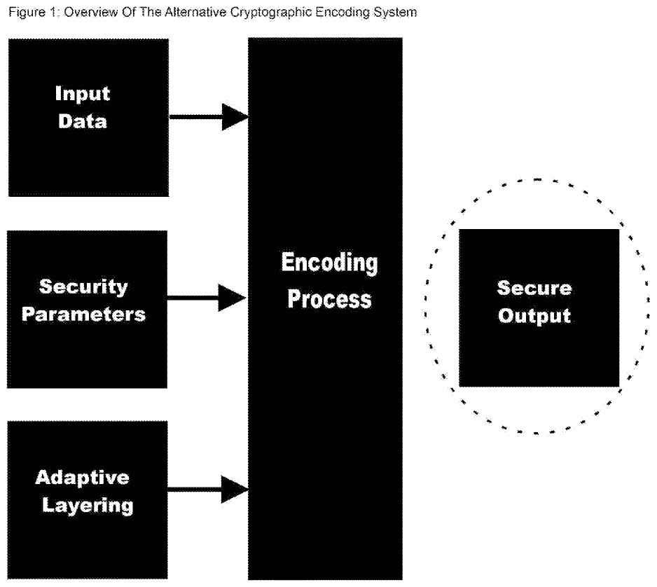

1. FIG. 1—Overview of the Alternative Cryptographic Encoding System

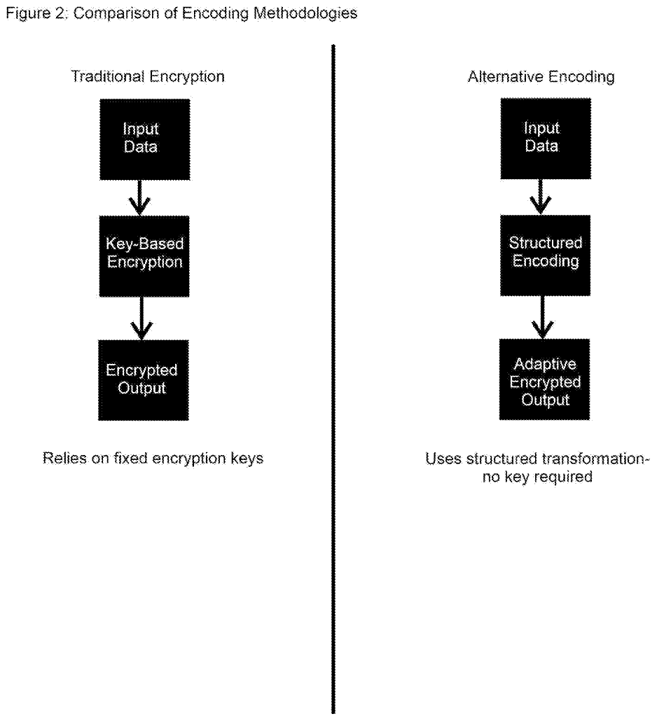

2. FIG. 2—Comparison of Encoding Methodologies

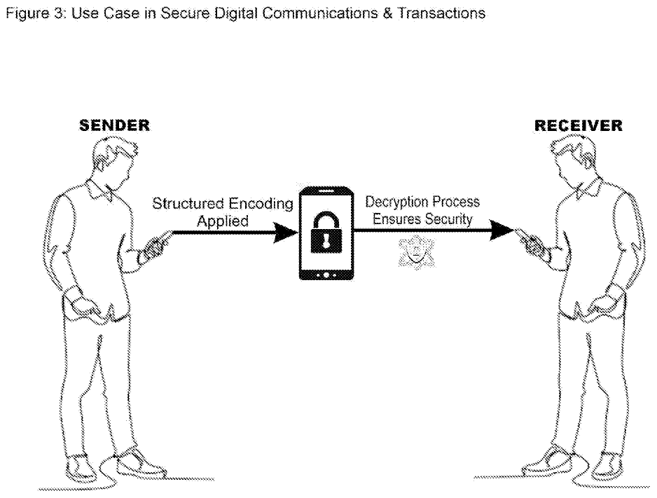

3. FIG. 3—Use Case in Secure Digital Communications & Transactions

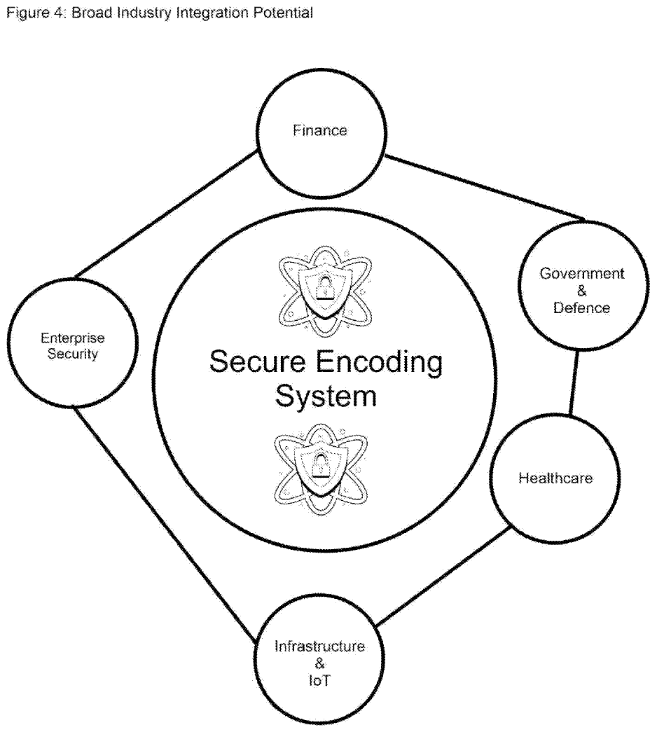

4. FIG. 4—Broad Industry Integration Potential

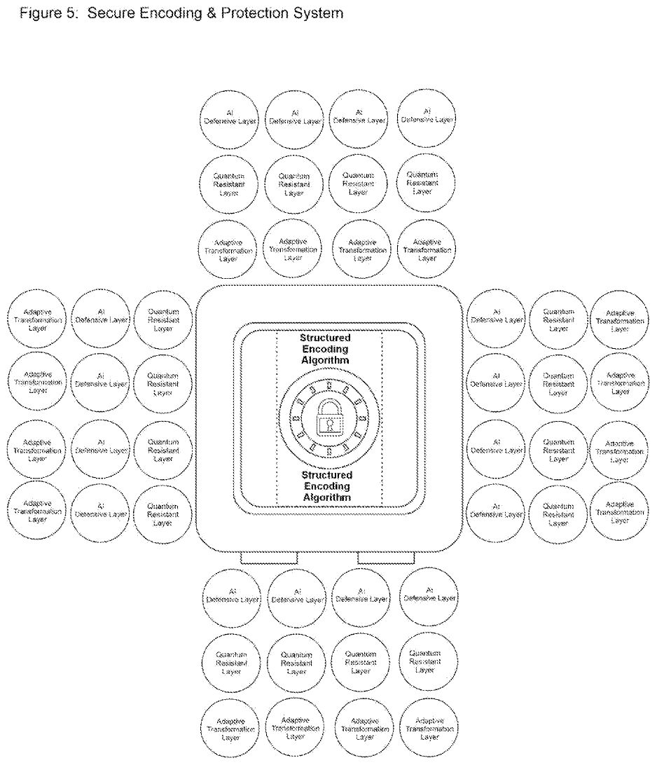

5. FIG. 5—Secure Encoding & Protection System

Note: The drawings/diagrams will be submitted separately in PDF format.

### DETAILED DESCRIPTION OF THE INVENTION

### General Cryptographic Encoding Model

This invention introduces a non-traditional encryption model, ensuring non-reversibility of encoded data while maintaining data security across multiple applications.

Structured cryptographic encoding process—A method applying an alternative encryption model for securing digital data.

Configurable encryption parameters—A security model enabling encryption adaptability in response to evolving cybersecurity threats.

Unlike conventional encryption, this system removes dependency on traditional computational keys and instead applies a structured cryptographic encoding model, making decryption by quantum algorithms or AI-based models infeasible.

### Refined Explanation of Real-Time Adaptation

This system enables a dynamically adaptable transformation process, ensuring encryption integrity is maintained as security conditions evolve. The adaptation occurs without reliance on predefined static encryption parameters, allowing it to respond effectively to changing security environments.

### Industry-Wide Security Applications

This invention is applicable in, but not limited to, the following industries:
Secure digital communications (Military, Government, Enterprise Security)
Financial transaction protection (Blockchain, Banking, Payment Networks)
Enterprise cybersecurity & data encryption (Cloud security, Confidential Data Storage)
Healthcare information security (Patient records, Biometric data)
Critical infrastructure protection (Telecommunications, Smart Infrastructure, Energy Sector)

1. Core Encryption System
A cryptographic encoding system for securing digital communications and data protection.
Includes quantum-resistant protection and adaptive encryption for industry-specific security.

2. Authentication & Digital Identity Protection
A method for securing authentication and communication through an encryption framework.
Includes structured encoding for enhanced security in communications.

3. Data Security & Access Control
A cryptographic method for securing access control and sensitive digital assets.
Includes AI-resistant encoding methods and multi-layer encryption.

4. Post-Quantum Security Adaptation (Dependent on claim 1)

5. AI-Resistant Identity Verification (Dependent on claim 2)

6. Secure Digital Environment Integration (Dependent on claim 3)

7. Dynamic Encoding Adaptation for Varied Security Environments (Dependent on claim 3)

8. Multi-Layer Transformation for Adaptive Security (Dependent on claim 3)

9. Secure Al-Generated Cryptographic Patterns (Dependent on claim 2)

10. Enhanced Security for Structured Encoding in Communications (Dependent on claim 2)

11. Industry-Specific Encryption Customization (Dependent on claim 3)
